(19) United States
(12) Patent Application Publication
(10) Pub. No.: US 2013/0143703 A1
(43) Pub. Date: Jun. 6, 2013

(54) TOOTHED BELT WHEEL

(71) Applicant: Florian Schlumpf, Vilters (CH)

(72) Inventor: Florian Schlumpf, Vilters (CH)

(73) Assignee: Haberstock Engineering GmbH, Lauchringen (DE)

(21) Appl. No.: 13/698,635

(22) PCT Filed: May 4, 2011
(86) PCT No.: PCT/IB11/51964

§ 371 Date: Dec. 4, 2012

(30) Foreign Application Priority Data
May 18, 2010 (CH) 00780/10

(51) Int. Cl. F16H 55/30

(52) U.S. Cl. CPC F16H 55/30
USPC 474/152

(57) ABSTRACT

The present invention relates to a toothed belt wheel (1), in particular for bicycles or motorcycles, for torque transmission from the crankshaft or engine shaft to the rear wheel. The toothed belt wheel (1) consists of individual disc-shaped elements (2, 3, 4; 10, 11, 12), which are fixedly connected to one another to form a unit. The toothed belt disc (9) of the toothed belt wheel (1), which is intended for the engagement of a toothed belt, is assembled from at least two elements (2, 3; 10, 11), specifically a carrier disc (2) and one or more tooth discs (4). In addition, a flanged disc (3) can also be arranged on the toothed belt disc (9).

The present invention relates to a toothed belt wheel according to the preamble of claim 1.

Toothed belt wheels are currently present in manifold applications. They are also more and more prevalent as force transmission elements in bicycles and motorcycles, where they replace the previous chain drive. For chain drives, good lubrication is required. In contrast, toothed belt drives do not have to be oiled and unlike typical bicycle chains, modern toothed belts do not stretch and therefore do not have to be retensioned.

However, toothed belt drives require a very precise alignment of the belt alignment, which places high demands on the frame production and makes applications in the field of retrofitting practically impossible. Since additionally the production of the toothed belt wheels is relatively costly, only a restricted number of diameters and widths of toothed belt wheels are available. It is in turn difficult to impossible to adapt them to the exact belt line. Depending on the transmitted power, various belt widths are necessary. Wider belts are even more demanding in the alignment, however, and have the tendency toward higher transmission losses. Therefore, an ideal toothed belt for all applications does not exist.

Soiling is a large problem in conventional toothed belt wheels. Mud or dirt between the teeth of a toothed belt wheel can result in skips on the gear wheels. In winter, for example, snow is pressed into the tooth gaps and causes the belt to jump off Dirt and snow can also cause damage to the belt up to its cracking, since the belts are very sensitive to buckling and local overload.

It is the object of the present invention to implement a toothed belt wheel of the type mentioned at the beginning such that the above-mentioned disadvantages are substantially neutralized, and the toothed belt wheel is also usable in the field of retrofitting.

This object is achieved by a toothed belt wheel having the features of Patent claim 1. Further features and advantages of the present invention will be explained on the basis of the following description of preferred exemplary embodiments and with reference to the appended drawings

In the figures

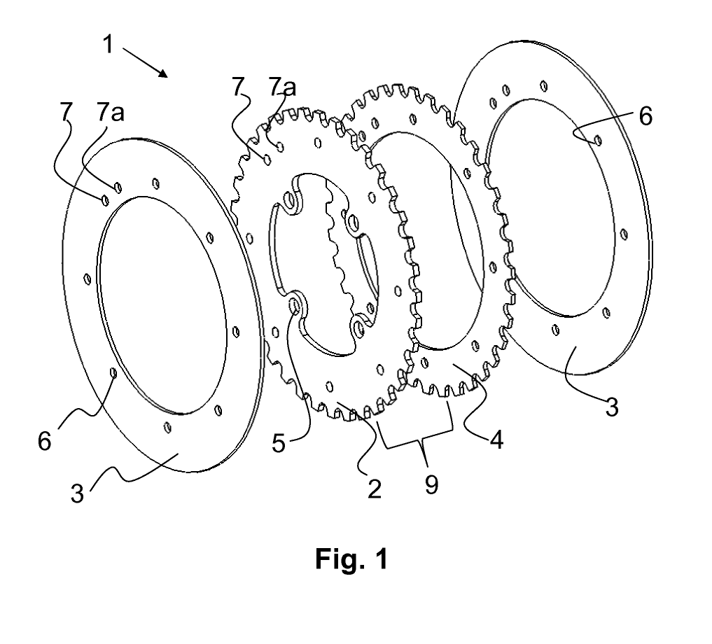

FIG. 1 shows a schematic illustration of the elements of an exemplary structure of a toothed belt wheel;

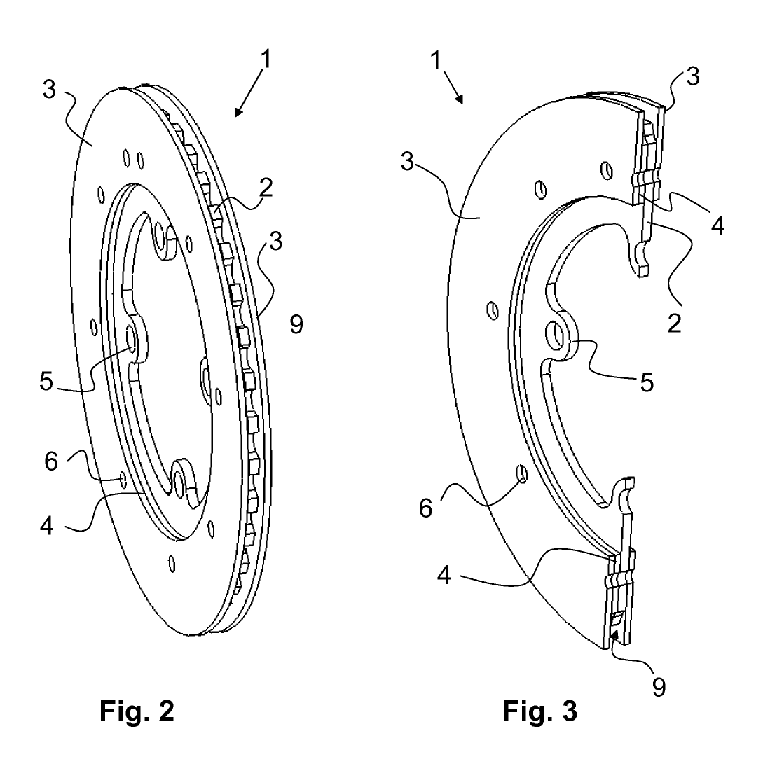

FIG. 2 shows a schematic illustration of the elements of the toothed belt wheel connected to form a unit;

FIG. 3 shows a vertical sectional illustration of the toothed belt wheel shown in FIG. 2;

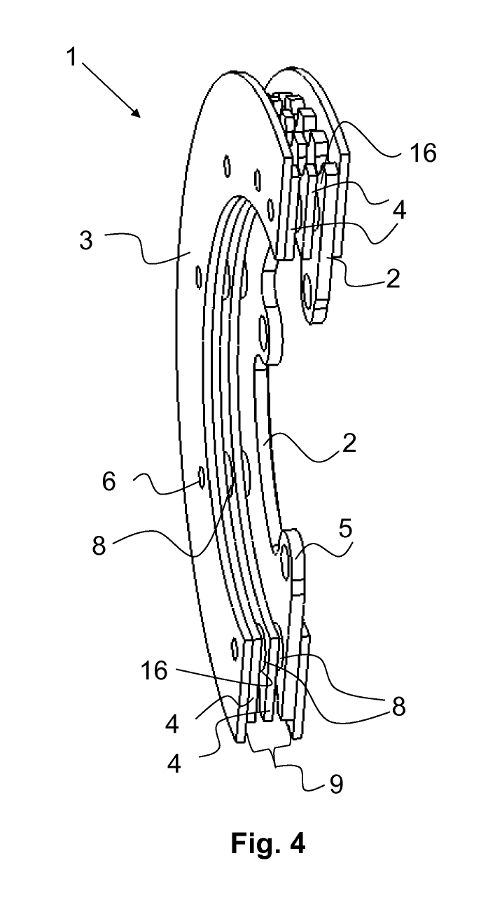

FIG. 4 shows a schematic illustration of a toothed belt wheel with spacer discs between the tooth discs or the carrier disc;

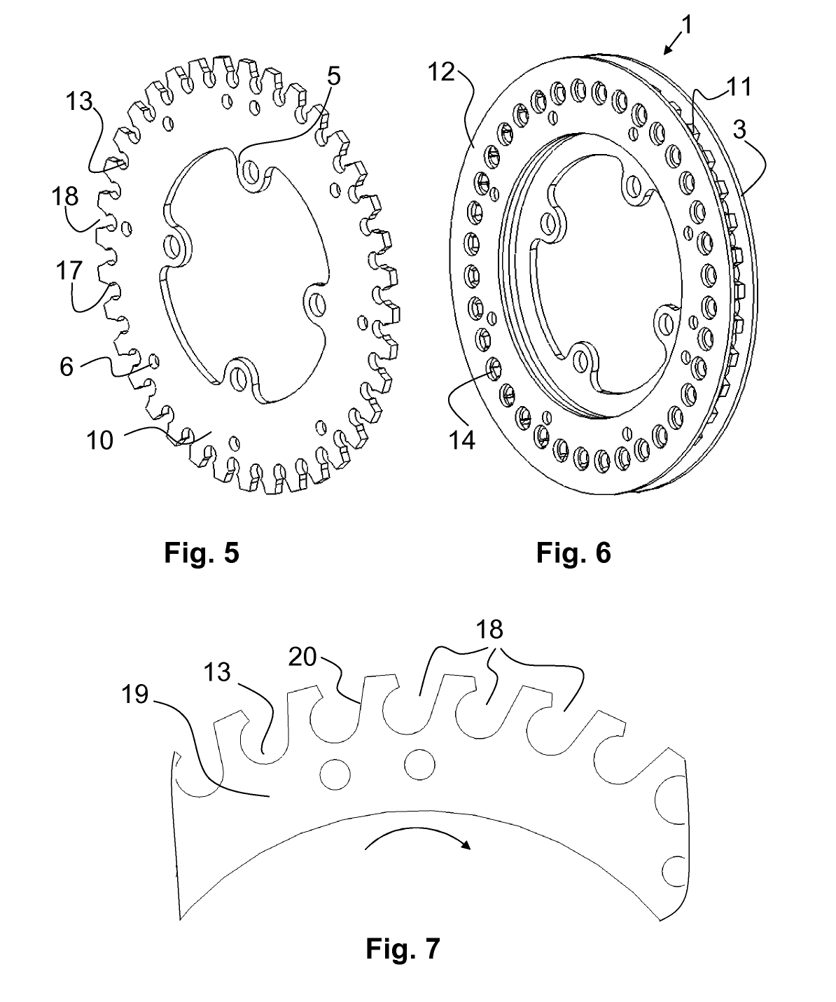

FIG. 5 shows a schematic illustration of a carrier disc having recesses in its tooth holes;

FIG. 6 shows a schematic illustration of a toothed belt wheel having boreholes in the flanged disc and recesses in the tooth holes;

FIG. 7 shows a schematic illustration of a detail of a toothed belt disc having asymmetrical gear teeth.

The present invention proposes assembling a toothed belt wheel, in particular for bicycles and motorcycles for torque transmission from the crankshaft or engine shaft to the rear wheel, from thin, disc-shaped elements. These elements are carrier discs, tooth discs, flanged discs, and spacer discs. The discs are combined as needed and connected to one another to form a fixed unit and form a toothed belt wheel. The discs of the toothed belt wheel enclosed by the toothed belt are designated as the toothed belt disc.

The carrier disc has a receptacle in the interior, which matches the common attachment standards for crankshafts or engine shafts and for the drive shafts. In the case of a bicycle drive, the receptacle corresponds to a standardized chain ring pitch circle diameter, in the case of a motorcycle drive, it corresponds to the gear teeth on the transmission output shaft. The carrier disc is used as an adapter when retrofitting a vehicle with chain drive to a toothed belt drive and has the toothed belt profile along the outer circumference. In addition, one or more thin tooth discs can now be attached to the left or right of the mentioned carrier disc. For a 6 mm wide belt, for example, a packet consisting of a carrier disc having corresponding receptacle and multiple tooth discs having a total thickness of 7 mm are connected to one another to form a toothed belt disc and, for an 11 mm wide belt, to form a toothed belt disc of 12 mm. Depending on the arrangement of the carrier disc within the toothed belt disc of a toothed belt wheel, arbitrary belt lines may be achieved for arbitrary belt widths, which can be varied at intervals which correspond to the thickness of these tooth discs.

By adapting the number of discs, it is possible to obtain the specific best solution for greatly varying applications in a simple and cost-effective manner. For a vehicle which is predominantly used on level ground and is driven by less practiced people in the comfort sector, a thin belt which only has minimal losses is sufficient. For an application in the heavy-duty field, a wider toothed belt wheel is configured without costly additional effort, which allows a substantially wider and therefore stronger belt to be used.

The individual tooth discs or carrier discs are producible cost-effectively by means of laser cutting or water jet cutting, for example, so that a large range of various disc sizes is possible at low prices, which is of interest above all for the retrofitting and small-scale production market.

Flanged discs can be attached on one side or if necessary on both sides of the tooth disc. They are used to guide the toothed belt to prevent possible running off of the belt.

FIG. 1 shows a schematic illustration of an exemplary structure of a toothed belt wheel 1 assembled from multiple elements. This simple structure contains one carrier disc 2, only one tooth disc 4, and a flanged disc 3 in each case on the right and left. The four discs are screwed together with one another using screws via the boreholes 6 to form a fixed unit, the toothed belt wheel 1. For this purpose, the boreholes 6 of the left flanged disc 3, for example, can have threaded bores for a screw connection. The discs also have a coding 7, 7a, in order to be able to assemble them correctly with respect to the gear teeth. In the example shown, the coding consists of two adjacent bores 7, 7a, which are to be arranged congruently one over the other during the assembly of the discs. Extensions run radially inward on the carrier disc 2 and form the receptacle 5. The assembled toothed belt wheel 1 is screwed onto the crankshaft or the drive shaft by means of this receptacle 5. In the example shown, the toothed belt encloses the carrier disc 1 and a tooth disc 4. The carrier disc 1 and the tooth disc 4 together form the toothed belt disc 9. Since the toothed belts 4 are very thin, approximately in the range of 2 to 4 mm—preferably 2 mm—the toothed belt disc 9 of a toothed belt wheel 1 consists in practice of multiple tooth discs 4 and one carrier disc 2, which has a thickness of approximately 2 to 4 mm—preferably 3 mm. Depending on the number of the tooth discs 4, the width of the toothed belt disc 9 can thus be adapted to a specific width of a toothed belt. Through the possibility of the variable arrangement of the carrier disc 2 within the toothed belt disc 9, the spacing of the belt plane in relation to the plane of the receptacle 5 can be varied. This allows an adaptation of the location of the belt plane, i.e., the belt alignment between the rear toothed belt wheel and the front toothed belt wheel in the case of retrofitting of a bicycle or motorcycle having chain drive to a toothed belt drive.

FIG. 2 shows the toothed belt wheel assembled with the elements shown in FIG. 1. The toothed belt wheel 1 consists in this simple configuration of a toothed belt disc 9 having a tooth disc 4 and a carrier disc 2 having the receptacle 5, and flanged discs 3 arranged on the right and left of the toothed belt disc 9. It is also conceivable that the toothed belt wheel 1 has no or only one flanged disc 3.

FIG. 3 shows a vertical section through the assembled toothed belt wheel 1 shown in FIG. 2. The disc-by-disc structure of the toothed belt wheel 1 made of the flanged discs 3, the carrier disc 2, and the tooth disc 4 can be recognized.

As already mentioned, soiling is a problem in conventional toothed belt wheels. FIG. 4 shows a first solution of how the dirt from toothed belts collecting in tooth gaps of the toothed belt wheel 1 can be removed from the tooth gaps. The individual tooth discs 4 arranged on one another to form a toothed belt disc 9 and the carrier disc 2 are spaced apart from one another by means of the spacer discs 8 arranged on the screw connection.

Depending on the thickness of the spacer discs 8, the intermediate space 16 between the discs 4, 2 can thus be varied. If dirt or snow is located in the tooth gaps of the tooth discs 4 or the carrier disc 2, it is pressed into the intermediate space 16 upon engagement of the teeth of the toothed belt in the tooth holes, without the toothed belts being lifted out of the tooth holes. Skipping or local overload of the toothed belt can thus be prevented.

A further possibility for removing the dirt collected in the tooth gaps of the toothed belt wheel 1 is that the individual tooth discs 4 and the carrier disc 2 are shaped such that the dirt can exit through cavities. Such a solution is shown on the basis of a carrier disc 10 in FIG. 5, for example. The gear teeth of the carrier disc 10 correspond along the outer circumference to the gear teeth of the carrier disc 2, as shown in FIG. 1. In the region of the apex 17 of the tooth gaps 18, the carrier disc 10 has a borehole 13 in each case, which leads to a depression of the tooth gaps 18. The tooth discs 11 are designed identically to the carrier disc 10 in the region of the gear teeth. The flanged discs 12 can also have corresponding boreholes 14. A toothed belt wheel 1 assembled using the mentioned discs 12, 11, 10 is shown in FIG. 6. The boreholes 13 in the tooth gaps of the individual discs 10, 11 result in a cavity in the toothed belt disc 9 below the apex 17 of the tooth gaps 18, in which the teeth of the toothed belt engage. If dirt is located in the tooth gaps of the toothed belt disc 9, it is pressed by the teeth of the toothed belt into the cavities and laterally outward through the boreholes 14 in the flanged disc.

FIG. 7 shows a schematic illustration of a detail of a tooth disc 19, in which the borehole 13 in the region of the apex 17 of the tooth gaps 18 is arranged offset in relation to the radially extending axis of symmetry of a tooth gap 18. In a toothed belt disc 9 constructed using such discs, these boreholes 13 also lead to a depression of the tooth gaps 18 and result in a cavity in the toothed belt disc 9. Dirt in the tooth gaps 18 is pressed by the teeth of the toothed belt into the cavities and laterally outward. The described offset borehole 13 has the result that the tooth gaps 18 of the discs and therefore also the teeth of the disc are shaped asymmetrically. A toothed belt running around tooth discs 19 having asymmetrical gear teeth only still presses against the front flanks 20 of the tooth discs 19 or the toothed belt wheel 1, respectively. Depending on the rotational direction of the disc 19, a large force transmission can therefore respectively only occur in one direction. If the disc shown in FIG. 7 rotates clockwise, as indicated by the arrow, the force transmission can then only occur from the toothed belt to the toothed belt wheel (rear drive in bicycle or motorcycle). For a force transmission from the toothed belt wheel to the toothed belt in the same rotational direction (front drive in bicycle), the toothed belt wheel must be turned by 180°. The toothed belt then presses against the rear flank 20 of the tooth gap 18. Through the disc-by-disc structure of the toothed belt wheel 1, the desired combination of discs can be joined together and assembled to form a unit depending on the use.

The production of the individual elements 2, 4, 10, 11 of a toothed belt disc 9 for a toothed belt wheel 1 in the form of thin discs allows highly wear-resistant materials to be selected as the material, for example, spring strip steel, which is in turn possible by milling, sintering, injection molding or using other known methods applied in toothed belt wheel production.

The modular structure also allows the use of multiple toothed belt discs adjacent to one another, which can in turn be separated if needed using a flanged disc. It would thus be possible in the case of rarely changing load cases to change the toothed belt from one disc to a parallel disc. This could be made easier, for example, in that a simple belt tensioner having a quick-release closure can be disengaged, which makes it possible to turn over the belt by hand.

1. A toothed belt wheel for torque transmission from a crankshaft or engine shaft to a rear wheel, wherein the toothed belt wheel is constructed from individual disc-shaped elements which are fixedly connected to one another to form a unit, and wherein the toothed belt wheel comprises a toothed belt disc which is intended for the engagement of a toothed belt and is formed from at least two of the disc-shaped elements.

2. The toothed belt wheel according to claim 1, wherein the toothed belt disc is formed by a carrier disc and at least one tooth disc.

3. The toothed belt wheel according to claim 1, wherein the toothed belt disc having one carrier disc and having one or more tooth discs and having at least one flanged disc are connected to one another to form a unit.

4. The toothed belt wheel according to claim 3, wherein spacer discs are provided on a screw connection of the toothed belt wheel between the individual tooth discs and the carrier disc and/or the flanged discs, in such a manner that the discs are arranged spaced apart from one another by a thickness of the spacer discs.

5. The toothed belt wheel according to claim 2, wherein the carrier disc and the tooth disc have a borehole in each case in a region of an apex of the tooth gaps, which boreholes result in a depression of the tooth gaps.

6. The toothed belt wheel according to claim 3, wherein the carrier disc and the tooth disc have a borehole in each case in a region of an apex of the tooth gaps, and the flanged disc has boreholes, which are arranged in such a manner that they are congruent with the boreholes of the tooth disc or the carrier disc.

7. The toothed belt wheel according to claim 5, wherein the boreholes in the region of the apex of the tooth gaps are arranged offset in relation to the radially extending axis of symmetry of a tooth gap.

8. The toothed belt wheel according to claim 1, wherein the tooth discs have a thickness between 1 mm and 3 mm, and the carrier disc has a thickness between 2 mm and 4 mm.

9. The toothed belt wheel according to claim 1, wherein the tooth discs have a thickness of 2 mm, and the carrier disc has a thickness of 3 mm.
